(19) United States
(12) Patent Application Publication
(10) Pub. No.: US 2012/0192436 A1
(43) Pub. Date: Aug. 2, 2012

(54) Electric Hair Trimmer Having Arched Detailer

(75) Inventor: David Yet Toy, Madison, WI (US)

(73) Assignee: ROVCAL, INC., Madison, WI (US)

(21) Appl. No.: 13/017,248

(22) Filed: Jan. 31, 2011

(51) Int. Cl. B26B 19/06; B26B 19/28; B26B 19/38; B26B 19/04

(52) U.S. Cl. 30/216; 30/225; 30/208; 30/223; 132/200

(57) ABSTRACT

An electric hair trimmer includes a handle having a drive motor and a cutter head connected to the handle. The cutter head includes a housing having a pair of cutting blades extending from an end of the housing and disposed adjacent to one another. At least one of the blades is adapted for motion relative to the other blade to cut hair, and each of the blades has a curved shape at a terminal end.

### FIELD

The present disclosure relates generally to electric trimmers, and more particularly to an electric hair trimmer having a curved or arched detailer for precise trimming.

### BACKGROUND

Trimming facial, head and other body hair sometimes requires very precise work. For example, precise trimming may be required for a facial hair style with detailed patterns or lines.

Most conventional electric hair trimmers include blades, such as “T” blades, that have a straight or linear edge. The body of such a trimmer houses a motor, and the head includes a stationary blade (i.e., a comb) and a movable blade (reciprocating or oscillating) that slides against the stationary blade to form a cutter blade. At least some conventional electric trimmers have cutter blades that are sized to facilitate a more detail-oriented trimming operation (e.g., an eyebrow trimming operation).

Because most known detail trimmers have cutter blades with cutting edges that are linear, the amount of detail that can be achieved is limited. This linear or straight edge presents the user with 2 options for detailed cutting: (1) use the edge of the trimmer to trim small areas, or (2) use a small width blade for detailed cutting. Option 1 is limited because the effective cutting area of a conventional trimmer does not extend all the way to the edge of the trimmer. Because of this, trimming using the edge is not satisfactory. Option 2 is limited for the same reason as option 1, the effective cutting area does not extend to the edge, and because the blade is smaller.

Both conventional options are also limited to straight line cutting, and cannot be easily used for point trimming or for contour or curved cutting. Moreover, neither option is comfortable for the user, for among other reasons, the straight blade may cause scraping of sensitive skin.

Conventional trimmer blades are therefore not satisfactory for detailed cutting, and a more comfortable, easy-to-use solution for detailed cutting, including point trimming, contour cutting and small area cutting is needed.

### BRIEF SUMMARY

In one aspect, an electric hair trimmer includes a handle including a drive motor and a cutter head connected to the handle. The cutter head includes a housing including a pair of cutting blades extending from an end of the housing and disposed adjacent to one another. At least one of the blades is adapted for motion relative to the other blade to cut hair, and each of the blades has a curved shape at a terminal end.

In another aspect, a hair trimming kit includes a handle including a drive motor and a drive pin. A first cutter head is releasably connected to the handle. The first cutter head includes a housing including a pair of first cutting blades extending from an end of the housing and disposed adjacent one another. At least one of the first cutting blades is adapted for motion relative to the other blade to cut hair, and each of the blades has a curved shape at a terminal end. A second cutter head is releasably connected to the handle. The second cutter head includes a housing including a pair of second cutting blades extending from an end of the housing and disposed adjacent one another. At least one of the second cutting blades is adapted for motion relative to the other blade to cut hair, and each of the blades of the second cutter head has a linear shape at a terminal end.

In still another aspect, a method of trimming hair uses a hair trimming kit including a handle having a drive motor and a drive pin. A first cutter head is releasably connected to the handle. The cutter head includes a housing including a pair of first cutting blades extending from an end of the housing and disposed adjacent to one another. At least one of the first cutting blades is adapted for motion relative to the other blade to cut hair, and each of the blades has a curved shape at a terminal end. A second cutter head is releasably connected to the handle, the second cutter head comprising a housing including a pair of second cutting blades extending from an end of the housing and disposed adjacent one another. At least one of the second cutting blades is adapted for motion relative to the other blade to cut hair, and each of the blades has a linear shape at a terminal end. The method includes trimming hair using the second cutter head, disconnecting the second cutter head from the handle and connecting the first cutter head to the handle, and detail trimming hair using the first cutter head.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a front perspective view of one embodiment of an electric hair trimmer having an arched detailer.

FIG. 2 is a front perspective view of a cutter head of the trimmer of FIG. 1.

FIG. 3 is a rear perspective view of the trimmer.

FIG. 4 is a rear perspective view of the cutter head.

FIGS. 5-6 are perspective views of a stationary blade of the cutter head.

FIG. 7 is a front view of the stationary blade.

FIGS. 8-9 are perspective views of a movable blade of the cutter head.

FIG. 10 is a front view of the movable blade.

FIG. 11 is a bottom perspective view of the cutter head with portions removed for clarity.

FIG. 12 is a rear perspective view of the cutter head with portions removed for clarity.

FIG. 13 is similar to FIG. 12 but showing a movable blade moved to one side of the head.

FIG. 14 is similar to FIG. 13 but showing the movable blade moved to the opposite side of the head.

FIG. 15 is an exploded perspective view showing the cutter head disconnected from the handle.

FIG. 16 is an exploded perspective view showing a second, conventional cutter head disconnected from the handle.

### DETAILED DESCRIPTION

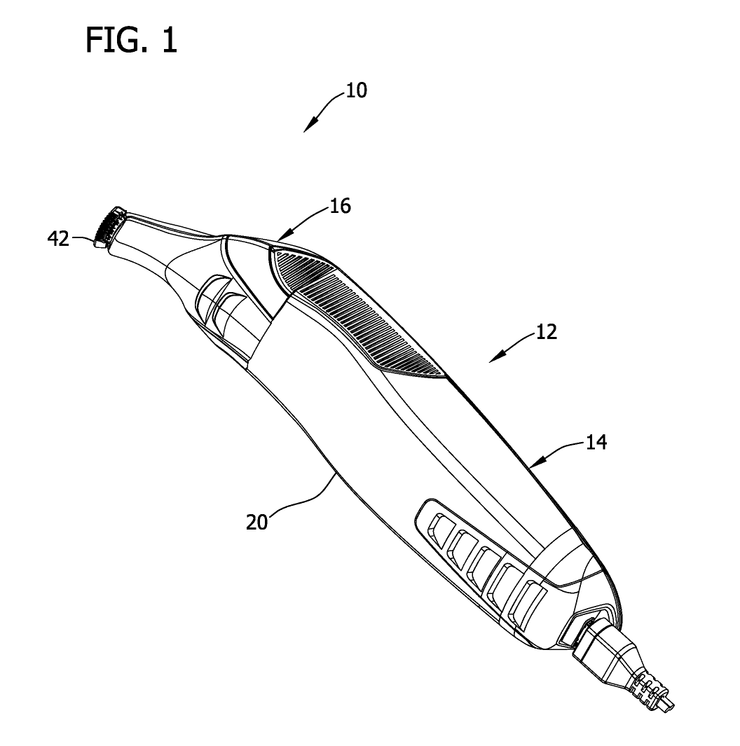

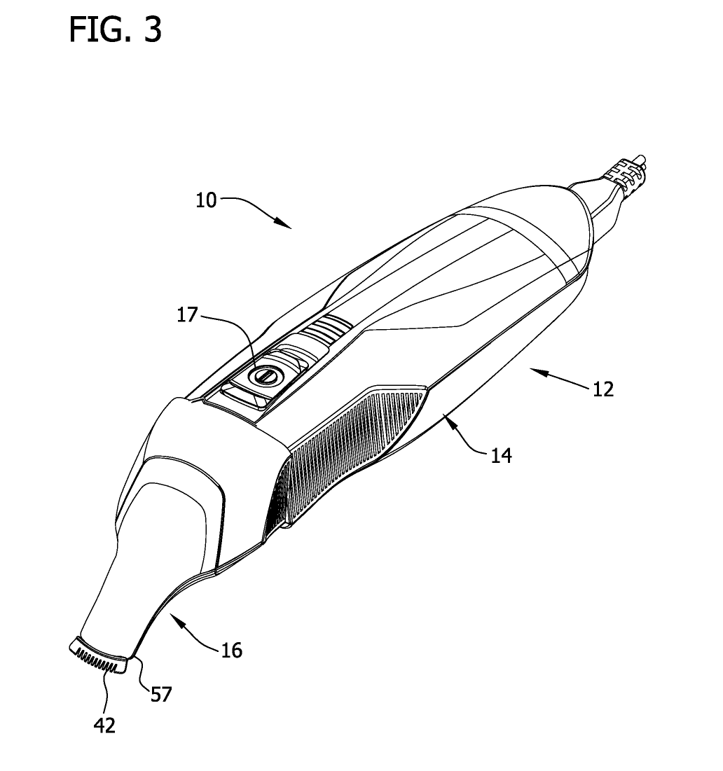

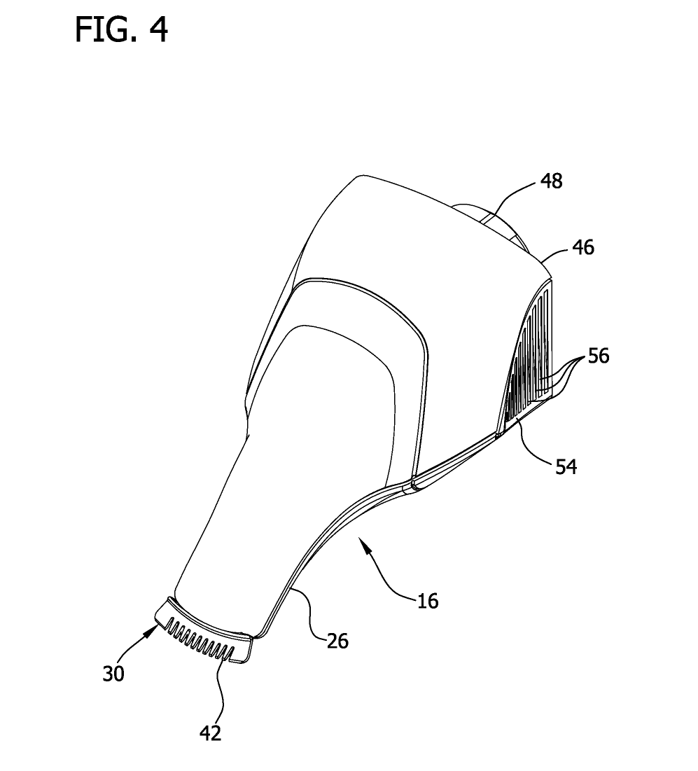

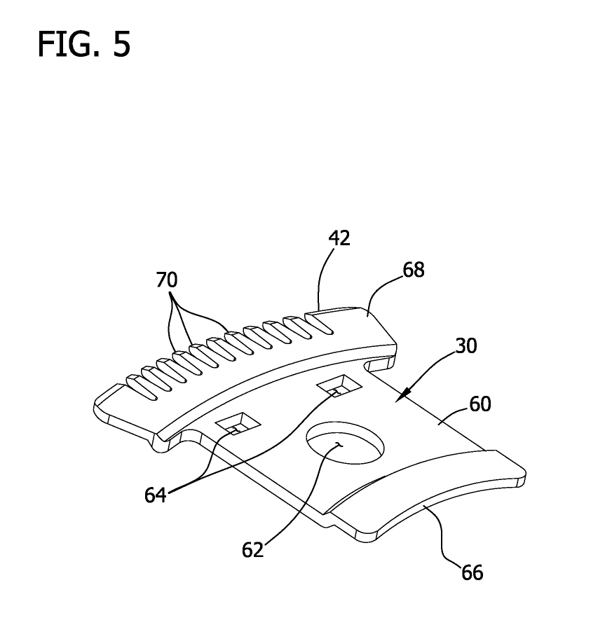

Referring now to the drawings, and in particular to FIGS. 1-4, an electric trimmer according to one embodiment is indicated generally by the reference number 10. This trimmer 10 forms a portion of a larger shaving kit sold as REMINGTON® Model WPG-2000, designed for trimming or shaving human body hair. However, other types and models of shavers and trimmers are contemplated within the scope of this disclosure. Embodiments of this disclosure may be used for cutting/trimming facial hair including eyebrows and sideburns, head hair, (e.g., trimming hair on top of or on the back of the head) leg hair, other body hair, and may be used in non-human applications such as trimming pet hair.

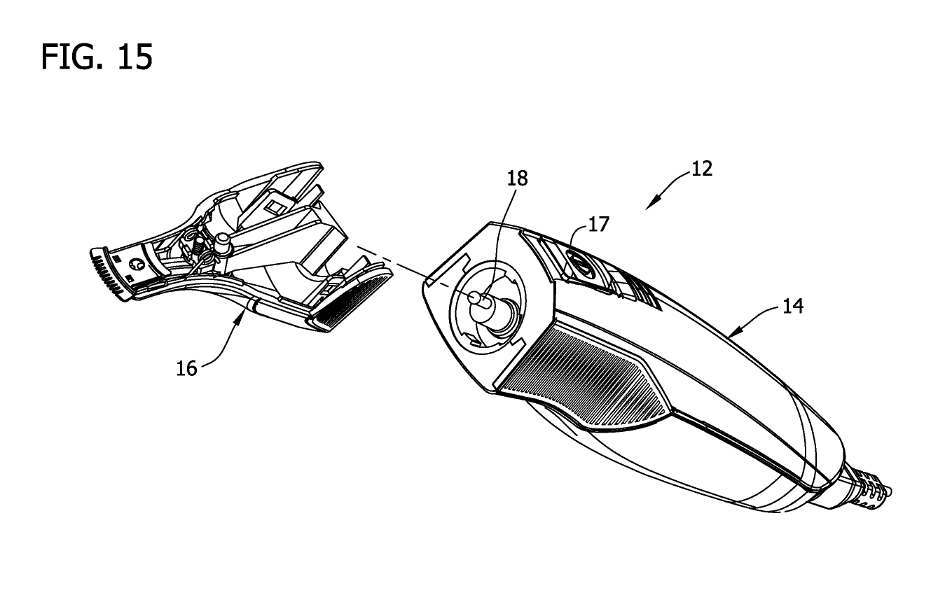

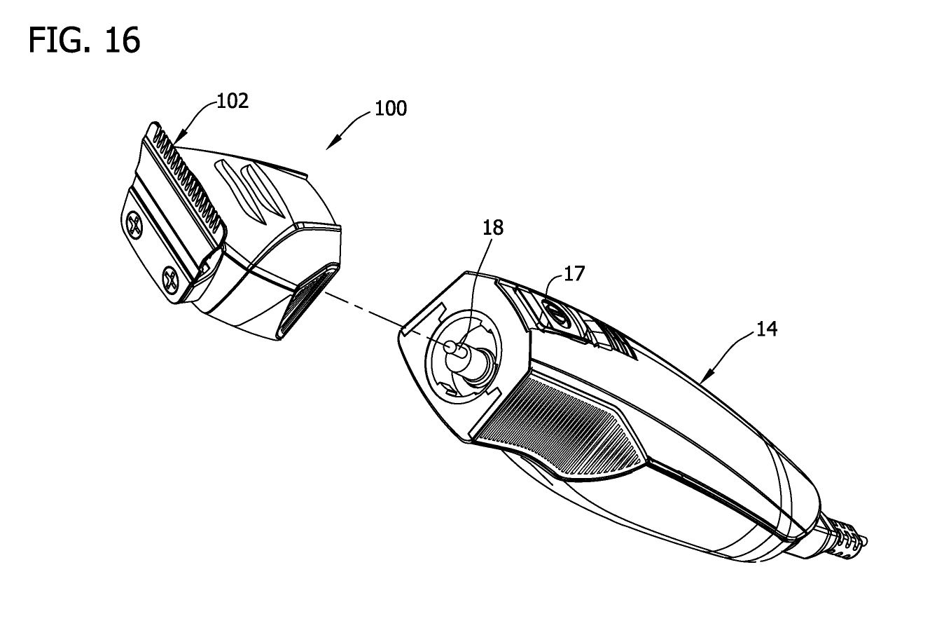

In the illustrated embodiment, the trimmer 10 comprises a body, generally indicated at 12, including a handle portion 14, and a cutter head, generally indicated at 16 that may be releasably connected to the body. While not illustrated in the drawings, the body 12 houses a suitable rechargeable battery, a motor, and associated electronics (e.g., circuitry), all of which are known to those skilled in the art for operating the trimmer. An electrical socket for charging the battery is accessible by a user on an exterior of the body 12. The body also includes a user interface, e.g., a power switch 17 shown in FIGS. 15 and 16, for operating the trimmer 10, and an upper section 20 at which the cutter head 16 removably connects to the body 12. The body 12 includes a drive pin 18 (e.g., an eccentric drive pin or an oscillating drive pin) shown in FIGS. 15 and 16 extending from the top of the body. The drive pin 18 is operatively connected to the motor and is configured for operative connection with the cutter head 16 as further described below. It is understood, however, that the cutter head 16 may be releasably connectable to the body 12 in another suitable manner, and/or it may be operatively connected to the motor in another suitable manner, without departing from the scope of this invention.

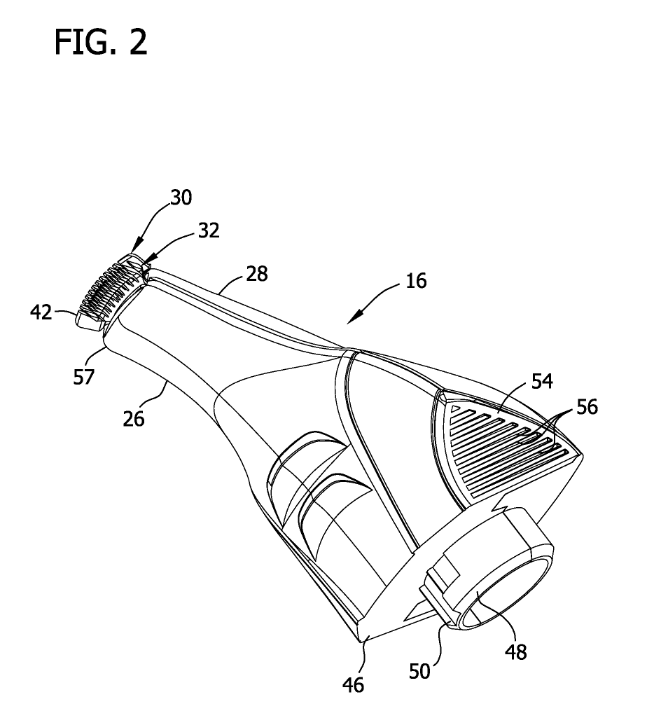

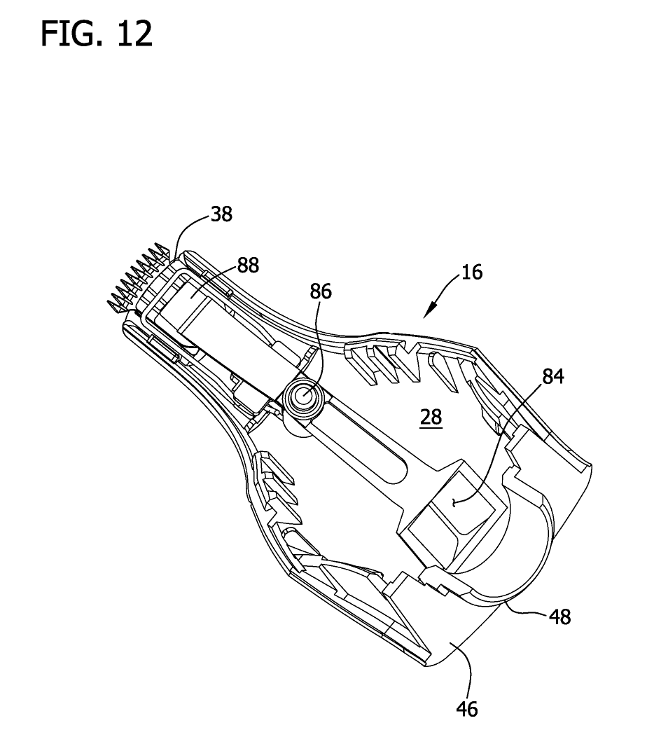

As illustrated in FIGS. 2, 4 and 11-12, the cutter head 16 of one embodiment suitably comprises a two-piece housing including a lower shell 26 and an upper shell 28 that are configured for assembly with each other to house a stationary blade 30, a movable blade 32, and an arm 34 (broadly, a transmission) for transmitting power to the movable blade. The lower and upper shells 26 and 28 are configured to define an elongate slot 38 (FIG. 12) in the assembled housing (FIGS. 1-4) from which the blades extend for trimming hair. As shown, the teeth 70 and 80 of the blades 30, 32 extend outward from the slot 38 of the housing, and at least the stationary blade defines a curved front edge 42 or terminal end of the cutter head 16.

As best shown in FIG. 2, a bottom end 46 of the cutter head 16 includes a hollow projection 48 configured to be received in the upper section 20 of the handle portion 14. The projection 48 includes grooves 50 that are engaged by complementary features (e.g., a “bayonet” connection) in the handle portion 14 to lock the cutter head 16 and handle portion together. To secure the cutter head 16 to the handle portion 14, the projection 48 is inserted into the opening in the upper section 20 and then twisted to engage the lock mechanism. To disassemble, the cutter head 16 is twisted in the opposite direction to disengage the lock mechanism, and the head is pulled out from the upper section 20 of the handle portion 14. Note that there is no electrical connection between the cutter head 16 and the body 12 or handle portion 14, but rather only mechanical connections. And in this embodiment, no tools are required to join the cutter head 16 and the body 12. Additionally, the user need not touch the blades in order to replace the cutter head 16. Sides of the bottom end 46 of the head 16 may include an arched area 54 having elongate ridges 56 to help the user secure the head 16 to the handle portion 14.

Referring to FIGS. 1-4 and 13-14, the cutter head 16 tapers from a relatively large diameter at its bottom end 46 to a much smaller, narrower top end or neck area 57 adjacent the blades 30, 32. The size of the bottom end 46 generally coincides with the diameter of the top of the handle portion 14 to help facilitate the connection of the head 16 to the handle portion. The neck area 57 adjacent the blades has a size or width slightly larger than that of the blade 32, which helps the trimmer 10 fit into smaller areas for detail trimming. The size differential between the handle 14 and the blade end or neck area 57 of the trimmer 10 also facilitates good control of the position of the blades during detail trimming.

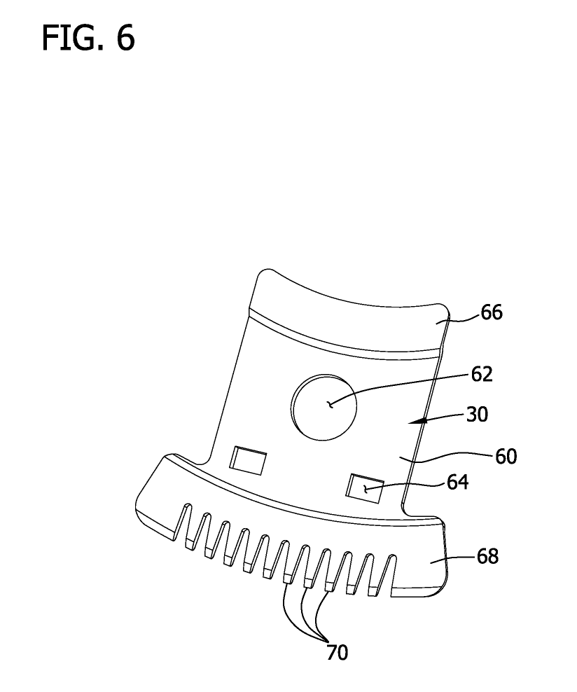

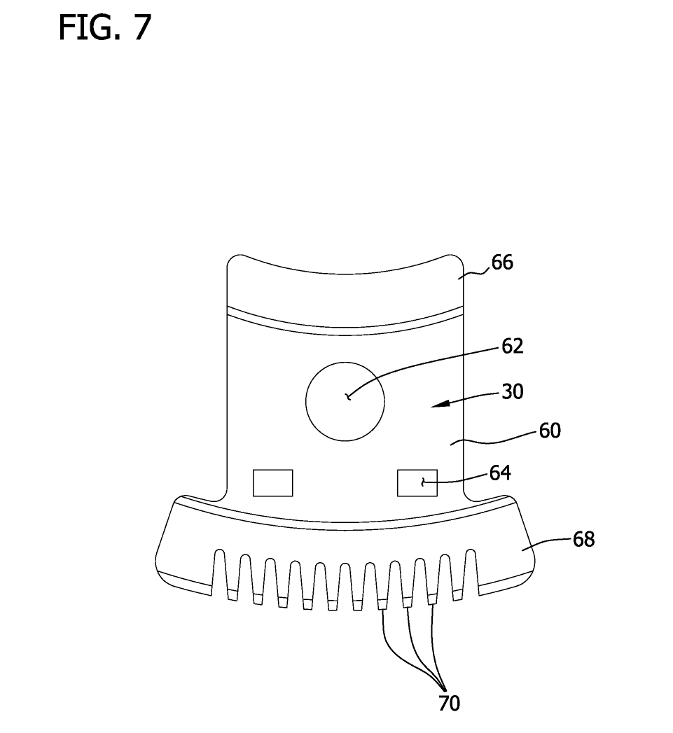

Referring to FIGS. 6-7, the stationary blade 30 includes a mounting portion 60 having a round hole 62 therein for receiving a fastener (not shown) that secures the blade 30 to the upper shell 28 of the cutting head 16. The mounting portion 60 also includes two square openings 64 that receive projections from the upper shell to help prevent the stationary blade from rotating. The mounting portion further includes a stepped portion 66 that facilitates smooth grinding and makes the blade easier to manufacture.

The stationary blade 30 also includes a curved blade portion 68 extending from the mounting portion, opposite from the stepped portion 66. The curved blade portion 68 of this embodiment forms a convex curve, though it is contemplated to be a concave curve. The curved blade portion 68 in this embodiment has a radius of about 23.46 mm (0.92 inches). In other embodiments, the curved blade portion may have a radius in the range of about 19 to about 28 mm, or even about 14 to about 33 mm. The curved blade portion has a width of between 3 and 17 mm, or more typically between 8 and 12 mm, or in one embodiment about 10 mm. Note that a standard trimmer blade is about 30 mm in width. As shown, the stationary blade 30 has a plurality of teeth 70, in this embodiment ten teeth, though it may have more or less than ten teeth in other embodiments. The spacing between teeth 70 in this embodiment is designed for cutting human hair, though other spacings and uses are contemplated. As noted above, the teeth 70 of the stationary blade 30 define a curved front edge 42 of the cutter head 16.

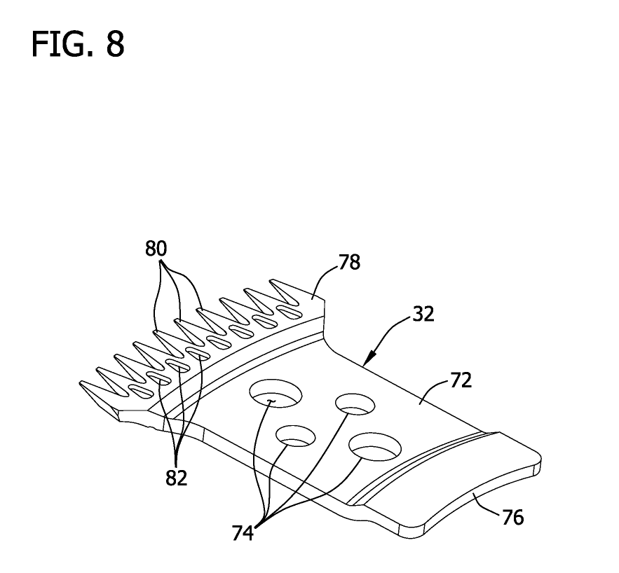

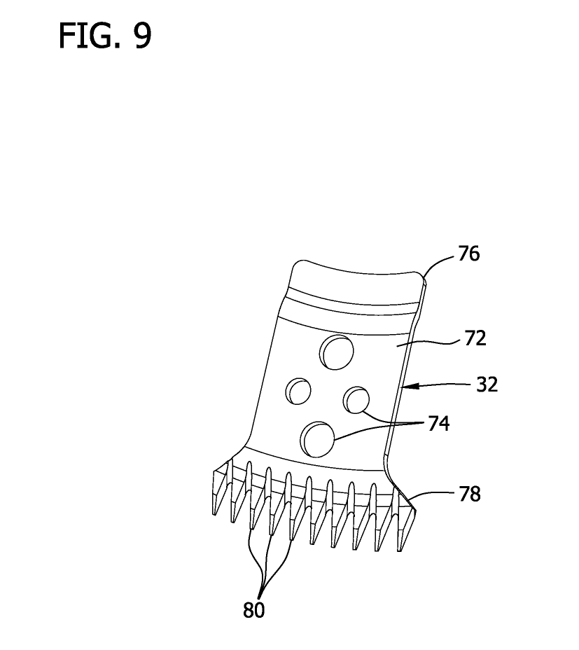

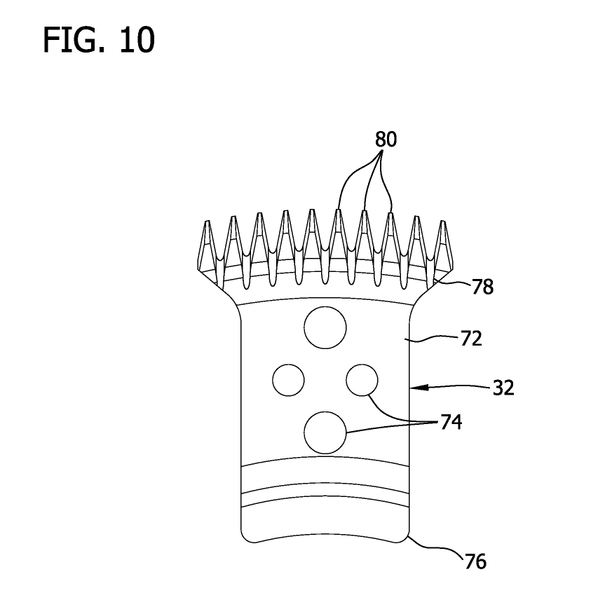

Referring to FIGS. 8-10, the movable blade 32 includes a mounting portion 72 having four round holes 74 therein for receiving fasteners that secure the movable blade to the arm 34 described below. The mounting portion 72 further includes a stepped portion 76 similar to that of the stationary blade.

The movable blade 32 also includes a curved blade portion 78 extending from the mounting portion 60, opposite from the stepped portion 66. The curved blade portion 78 of this embodiment has a radius of about 23.00 mm (0.91 inches). The curved blade portion 78 of the movable blade 32 is slightly smaller than that of the fixed blade 30 for safety, e.g., the movable bladed is sized to ensure that the movable blade 32 does not travel outside either edge of the fixed blade. In other embodiments, the curved blade portion 68 may have a radius in the range of about 18 to about 28 mm, or even about 14 to about 32 mm. As shown, the movable blade 32 has a plurality of teeth 80, in this embodiment ten teeth, though it may have more or less than ten teeth in other embodiments. The curved blade portion 78 also includes indentations 82 between each tooth for receiving oil. The indentations 82 may be formed such that the curved blade portion 78 holds oil and the oil need not be replaced.

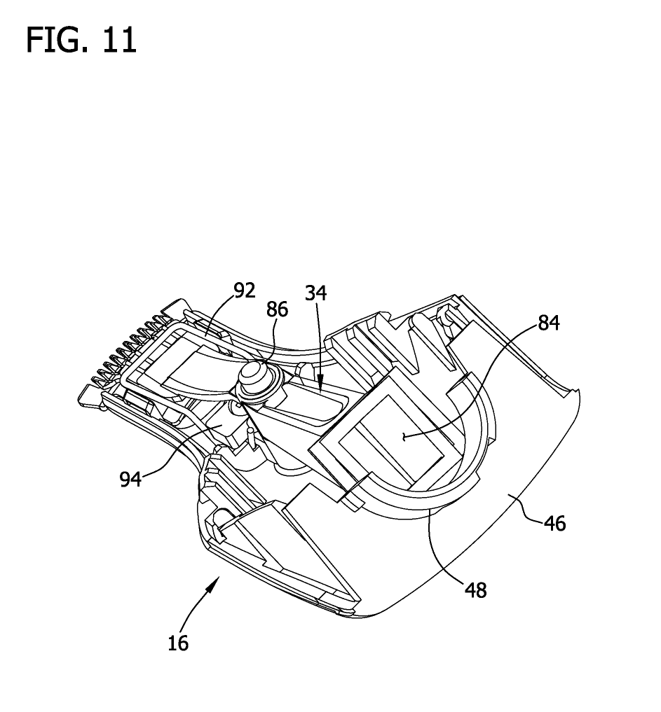

Referring to FIGS. 11-12, the arm 34 extends generally from the bottom end 46 of the cutter head 16 to its connection with the movable blade 32. At the bottom end 46, the arm 34 includes a receptacle 84 for receiving the drive pin. In this embodiment, the receptacle 84 is rectangular, though other shapes are contemplated.

A boss 86 extends upward from the upper shell 28 of the cutter head 16. The arm 34 includes a opening near its mid-point for receiving the boss 86 for attaching the arm to the boss and thus to the upper shell 28. This attachment point at boss 86 forms the pivot point or fulcrum of the arm 34. The movable blade 32 is attached to a forward end 88 of the arm. In this embodiment, the forward end 88 has four projections sized to be received in complementary holes 74 of the movable blade 32 for attachment of the blade. Other attachment mechanisms are contemplated.

Note that the fulcrum of the arm 34 may be disposed off-center of the arm, away from the mid-point of the arm, toward the forward end of the arm. This will cause decreased movement (sometimes referred to as “throw”) of the movable blade 32, which may be advantageous for smaller blades. Similarly, the fulcrum may be disposed toward the rear end of the arm 34 to increase the movement of the blade 32, e.g., for larger blades.

The movable or reciprocating blade 32 is biased against the stationary blade 30 via a suitable biasing member (e.g., a spring 92) such that the movable blade remains in sliding, face-to-face contact with the stationary blade 30 during operation. In this embodiment, the spring 92 is fixed at one end to a spring plate 94, which is secured to the upper section 16 by a suitable fastener.

The “throw” of the movable blade 32 is the distance travelled by the movable blade relative to the teeth 70 of the stationary blade 30. In one embodiment, the throw is 1.8, meaning that the movable blade moves a distance equal to 1.8 times the width of a tooth of the stationary blade 30. Alternatively, the throw may suitably be in the range of 1.2 to 2.5.

Note that the movable blade 32 of this embodiment moves in a “sweep” motion, as compared to some trimmers wherein the blade moves in a linear motion. Due to the sweep motion, a gap between the end of the stationary blade 30 and the end of the movable blade 32 remains constant during the motion. This constant gap helps to ensure uniform cut length and facilitates user comfort.

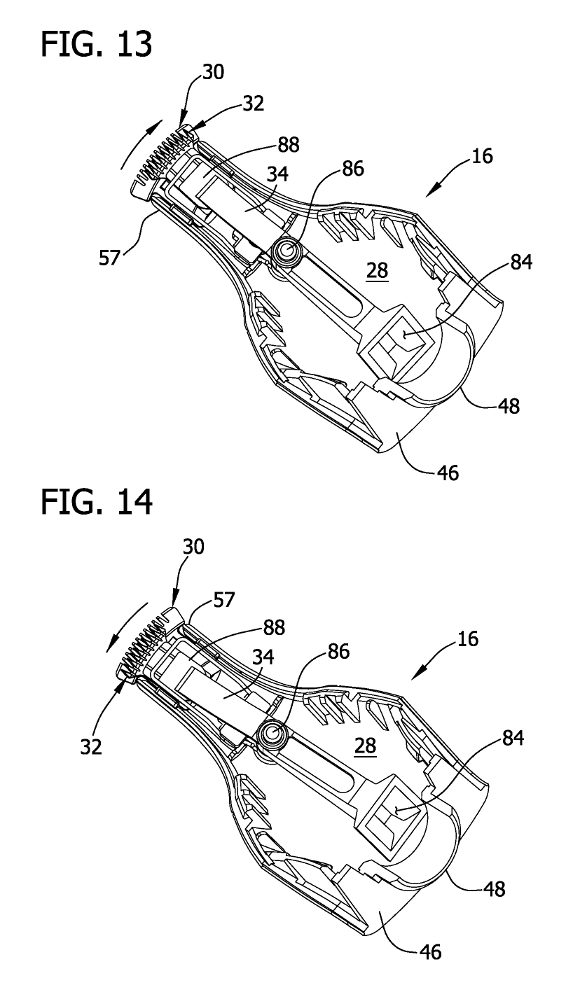

In operation, the drive pin rotates to move the arm laterally or side-to-side. Movement of the arm causes movement of the movable blade 32 relative to the stationary blade 30, as shown in FIGS. 13-14. Hair received within the teeth 70 and 80 of the blades 30, 32 is cut by the shearing action of the movable blade 32 relative to the stationary blade 30.

Unlike conventional trimmers, the disclosed trimmer 10 can be used for point trimming, small area trimming or for contour or curved cutting. This is accomplished without having to use the edge of the blade. The trimmer 10 is comfortable for the user, e.g., it does not cause scraping of sensitive skin because of the curved blade. “Round tips” or “comfort tips”, which are known in the art, can also be used. Because of the sweep motion of the movable blade 32, trim length is uniform.

As shown in FIGS. 15-16, the detail trimmer 10 may be part of a larger kit including a conventional linear or straight cutter head 100 (FIG. 16). The conventional trimmer (or second cutter head) includes substantially the same components disclosed above for the cutter head 16 (or first cutter head), except that blades 102 are larger and are not curved, and the size of the cutter head 100 is enlarged in width but decreased in length to correspond to the size of the blades.

In one exemplary hair trimming method, hair is first trimmed using the second or larger cutter head 100 (a more coarse trim using the larger head). After trimming is complete, the second head 100 is disconnected from the handle portion 14 by twisting the second head relative to the handle portion to disengage the head 100 from the locking mechanism. The second cutter head 100 is then removed from the handle 14. Next, the first cutter head 16 is placed in the handle portion 14 and locked in place (into the locking mechanism) by twisting the first cutter head 16 relative to the handle portion 14. Using the first cutter head 16, detail trimming is then performed. These steps may be performed in a different order, and the process may be repeated as necessary. Note that no tools are required to remove and replace the cutter heads.

Embodiments of the present disclosure enable a comfortable detail trim including point contact, contouring control and small area trimming without use of the edge of the blade. The detail trimmer provides a more comfortable trim at least in part because of the curved contour of the blade. The curved contour also reduces the risk of scraping in sensitive areas.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

What is claimed is:

1. An electric hair trimmer comprising:
a handle including a drive motor;
a cutter head connected to the handle, the cutter head comprising:
a housing including a pair of cutting blades extending from an end of the housing and disposed adjacent to one another, at least one of the blades adapted for motion relative to the other blade to cut hair, and each of the blades having a curved shape at a terminal end.

2. The trimmer of claim 1 wherein the cutter head is releasably connected to the handle.

3. The trimmer of claim 1 wherein the curved shape is a convex curvature.

4. The trimmer of claim 3 wherein one of the blades has a radius of between about 14 and about 33 mm, and the other of the blades has a radius of between about 14 and about 32 mm.

5. The trimmer of claim 1 wherein at least one of the blades has a width of between about 3 and about 17 mm.

6. The trimmer of claim 3 wherein one of the blades has a radius of between about 19 and about 18 mm, and the other of the blades has a radius of between about 18 and about 28 mm.

7. The trimmer of claim 6 wherein at least one of the blades has a width of between about 8 and about 12 mm.

8. The trimmer of claim 1 wherein the housing encloses an arm for transmitting power from the motor to one of the blades.

9. The trimmer of claim 8 wherein the arm is driven at an end thereof, pivots about a fulcrum, and is connected to one of the blades at an opposite end.

10. The trimmer of claim 9 wherein the fulcrum is offset such that the fulcrum is located closer to the blade than to the driven end.

11. The trimmer of claim 10 wherein the driven end includes a receptacle, and wherein the handle includes an eccentric drive pin operatively connected to the motor, the drive pin received in the receptacle for operatively connecting the motor to the arm.

12. The trimmer of claim 1 wherein there is no electrical connection between the handle and the cutter head.

13. The trimmer of claim 1 further comprising a kit including a second cutter head separate from the first-referenced cutter head, the second cutter head adapted to connect to the handle in replacement of the first cutter head.

14. The trimmer of claim 13 wherein the second cutter head has a blade of at least 30 mm in width.

15. A hair trimming kit comprising:
a handle including a drive motor and a drive pin;
a first cutter head releasably connected to the handle, the first cutter head comprising a housing including a pair of first cutting blades extending from an end of the housing and disposed adjacent one another, at least one of the first cutting blades adapted for motion relative to the other blade to cut hair, and each of the blades having a curved shape at a terminal end; and
a second cutter head releasably connected to the handle, the second cutter head comprising a housing including a pair of second cutting blades extending from an end of the housing and disposed adjacent one another, at least one of the second cutting blades adapted for motion relative to the other blade to cut hair, and each of the blades having a linear shape at a terminal end.

16. The hair trimmer kit of claim 15 wherein the curved shape is a convex curvature, and one of the blades has a radius of between about 14 and about 33 mm, and the other of the blades has a radius of between about 14 and about 32 mm.

17. The trimmer of claim 16 wherein at least one of the first cutting blades has a width of between 8 and 12 mm.

18. The trimmer of claim 17 wherein at least one of the second cutting blades has a blade of at least 30 mm in width.

19. The trimmer of claim 15 wherein there is no electrical connection between the handle and the cutter head.

20. A method of trimming hair using a hair trimming kit including a handle having a drive motor and a drive pin; a first cutter head releasably connected to the handle, the cutter head comprising a housing including a pair of first cutting blades extending from an end of the housing and disposed adjacent to one another, at least one of the first cutting blades adapted for motion relative to the other blade to cut hair, and each of the blades having a curved shape at a terminal end; a second cutter head releasably connected to the handle, the second cutter head comprising a housing including a pair of second cutting blades extending from an end of the housing and disposed adjacent one another, at least one of the second cutting blades adapted for motion relative to the other blade to cut hair, and each of the blades having a linear shape at a terminal end; the method comprising:
trimming hair using the second cutter head;
disconnecting the second cutter head from the handle and connecting the first cutter head to the handle; and
detail trimming hair using the first cutter head.

21. The method of claim 20 wherein disconnecting the second cutter head includes twisting the head relative to the handle to disengage the cutter head from a locking mechanism, removing the second cutter head from the handle.

22. The method of claim 21 wherein connecting the first cutter head to the handle includes placing a projection of the first cutter head into the handle and then twisting the first cutter head relative to the handle to engage the locking mechanism.

23. The method of claim 22 wherein no tools are required to connect the cutter heads to the handle.
